(19) United States
(12) Patent Application Publication
(10) Pub. No.: US 2014/0207415 A1
(43) Pub. Date: Jul. 24, 2014

(54) PERFORMANCE EVALUATION SYSTEM AND METHOD THEREFOR

(71) Applicant: ABB TECHNOLOGY LTD, Zurich (CH)

(72) Inventors: Naveen BHUTANI, Bangalore (IN); Srinivas Mekapati, Andra Pradesh (IN); Senthilmurugan Subbiah, Kovilpatti (IN); Shrikant Bhat, Nagpur MS (IN)

(73) Assignee: ABB TECHNOLOGY LTD, Zurich (CH)

(21) Appl. No.: 14/223,964

(22) Filed: Mar. 24, 2014

Related U.S. Application Data
(63) Continuation of application No. PCT/IB2012/001822, filed on Sep. 18, 2012.

(30) Foreign Application Priority Data
Sep. 23, 2011 (IN) 3284/CHE/2011

(51) Int. Cl. G01M 99/00

(52) U.S. Cl. CPC G01M 99/00
USPC 702/182

(57) ABSTRACT

An exemplary energy auditing system and a method for obtaining a validated performance solution for a plant are provided. An exemplary system and method includes at least one processor that obtains plant data for calculating one or more performance metrics. An initial benchmark is generated using performance metrics, a tunable process model and an optimizer. A rules engine is used for applying rules based on a dynamic input on the initial benchmark and current performance metrics, and for generating an output. A decision analysis module is used for validating if the output meets the specifications of the dynamic input using a what-if analysis. If the specifications are met, then the output is provided as a validated performance solution. If the specifications are not met, then the benchmark is evolved and the validating steps are repeated.

### RELATED APPLICATION

This application claims priority as a continuation application under 35 U.S.C. §120 to PCT/IB2012/001822, which was filed as an International Application on Sep. 18, 2012 designating the U.S., and which claims priority to Indian Application 3284/CHE/2011 filed in India on Sep. 23, 2011. The entire contents of these applications are hereby incorporated by reference in their entireties.

### FIELD

The present disclosure relates generally to performance evaluation methods and systems useful for monitoring and improving efficiency of industrial plants.

### BACKGROUND

Plant performance evaluation and monitoring is a basic component of industrial plants today. The performance may be related to production aspects, energy efficiency aspects or other such aspects. Such evaluation is done to see the deviation from an ideal performance criterion and subsequently to analyze and propose the potential for improvements. This concept has further evolved towards continuous real time monitoring of process/plant and condition monitoring of equipments. Further, targeted diagnostics is frequently performed in industries for gap identification and root cause analysis.

For example, energy auditing/assessment practices can involve evaluation of plant performance by an expert, based on domain experience. The alternatives/proposals for energy efficiency improvements can be given as a one-time service to the customer, though the plant operating conditions and constraints do vary over a period of plants operation. Therefore, it can be quite cumbersome for an energy auditor to gather information and apply domain knowledge/expertise on collective information to propose solutions for efficiency improvement with 100% confidence. Prior art exists in the area of energy monitoring (U.S. Pat. No. 7,373,221 B2), benchmarking/targeting (US 2005/0143953 A1, US 2005/0091102 A1) for identification of gaps (U.S. Pat. No. 6,877,034 B1, US 2005/0033631 A1, US 2008/0270078 A1 etc) and diagnostics (U.S. Pat. No. 7,552,033 B1). Also prior art exists in terms of use of an expert system for energy auditing (US20070239317).

However, even the optimization based approaches that are known fail to address the changing conditions of both plant and equipment that often result in conflicting objectives and also the changing user specifications or preferences of energy efficiency.

Presently techniques for plant performance and efficiency estimation do not address the variance of conditions and preferences over time. Since the benchmark is the backbone of the entire evaluation exercise, evaluation of correct benchmark can be important to effective evaluation.

There is, therefore, interest for improving the performance evaluation of the plants in terms of arriving at the benchmark considering the evolving nature of interactions between conflicting objectives, changing plant and equipment conditions, as well as user preferences.

### SUMMARY

A method is disclosed for obtaining a validated performance solution for a plant, the method comprising: obtaining plant data for calculating one or more performance metrics; generating an initial benchmark and current performance metrics for the plant using a tunable process model and an optimizer; applying rules on the initial benchmark and the current performance metrics based on a dynamic input and generating a first output; validating if the first output meets the dynamic input using a what-if analysis; generating an evolved benchmark based on the dynamic input by re-tuning the tunable process model; applying rules on the evolved benchmark and the current performance metrics and generating a second output; and providing a validated performance solution, wherein the validated performance solution is based on at least one of the initial benchmark or the evolved benchmark and the dynamic input.

A performance evaluation system is also disclosed for obtaining a validated performance solution for a plant, the system comprising: a data module for obtaining, pre-processing and storing plant data; a benchmark module having a tunable process model and an optimizer for providing at least one of an initial benchmark or a evolved benchmark; and a decision support engine having a knowledge base engine, a rules engine and a decision analysis module to generate a validated performance solution for a plant based on a dynamic input.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of an exemplary energy auditing system for obtaining a validated performance solution for a plant using a evolved benchmark; and

FIG. 2 is a flowchart representation of an exemplary method for obtaining a validated performance solution using an evolved benchmark.

### DETAILED DESCRIPTION

According to one aspect a method for obtaining a validated performance solution for a plant is provided. The plant includes a performance evaluation system having one or more processors. An exemplary method includes steps for obtaining, by the one or more processors, plant data for calculating one or more performance metrics; generating, by the one or more processors, an initial benchmark and current performance metrics for the plant using one or more performance metrics, a tunable process model and an optimizer; applying, by the one or more processors, rules on the initial benchmark and the current performance metrics based on a dynamic input and generating a first output; validating if the first output meets the dynamic input using a what-if analysis; generating, by the one or more processors, an evolved benchmark based on the dynamic input by tuning the tunable process model; applying, by the one or more processors, rules on the evolved benchmark and the current performance metrics and generating a second output; and providing, by the one or more processors, a validated performance solution, wherein the validated performance solution is based on at least one of the initial benchmark or the evolved benchmark and the dynamic input.

According to another aspect, a performance evaluation system is described for obtaining a validated performance solution for a plant. An exemplary system can include one or more processors having a data module for obtaining, pre-processing and storing plant data; a benchmark module having a tunable process model and an optimizer for providing at least one or an initial benchmark or an evolved benchmark; and a decision support engine having a knowledge base engine, a rules engine and a decision analysis module to generate a validated performance solution for the plant based on a dynamic input.

Definitions provided herein will facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, the term “plant” here refers to an industrial plant/process plant or a section of plant consisting of various equipments like heat exchangers, separators, pumps, energy recovery unit etc. It includes the land, buildings, machinery, apparatus, and fixtures employed in carrying on a trade or an industrial business. The term plant is used to include various types of production and service, such as for example, a cement plant to manufacture cement, a furniture plant for manufacturing furniture items, sugarcane plant for processing sugarcane to produce sugar and related products, power plant for producing electricity, and the like.

“Plant data” as referred herein includes plant equipment information (manufacturer specification, running condition, maintenance etc.), and plant operation information (from sensors, lab analysis etc).

The aspects described herein can provide an improved plant performance evaluation system, also referred herein as performance assessment system and a method for evaluation by providing a framework that adapts or modifies a benchmark used for evaluation of the plant, based on change in status of the plant, equipment or user preference or their combinations. User preferences herein after refer to various constraints that can be imposed on the plant, such as, energy constraints, output quantity, effluent regulation etc. While all the above mentioned constraints are applicable on the plant, some of the constraints will be rigid constraints and therefore cannot be relaxed. The user is able to determine one ore more constraints which have to be treated as rigid contraint. User preferences include the rigid constraints that are selected by the user.

In other words, a system and method disclosed herein can evaluate the performance of the plant based on multiple criteria and compare it with a benchmark, wherein the benchmark for the plant, referred herein as an “evolved benchmark” evolves based on the nature of interactions between conflicting objectives as well as user preferences, which change in time and space, thus, incorporating the variations in the changing operating conditions and user preferences in the performance evaluation framework. Thus, exemplary embodiments disclosed herein can advantageously use the evolved benchmark by considering the evolving nature of plant conditions and user preferences to assist decision makers and generate a validated performance solution to correspond to dynamic needs of the plant and the user.

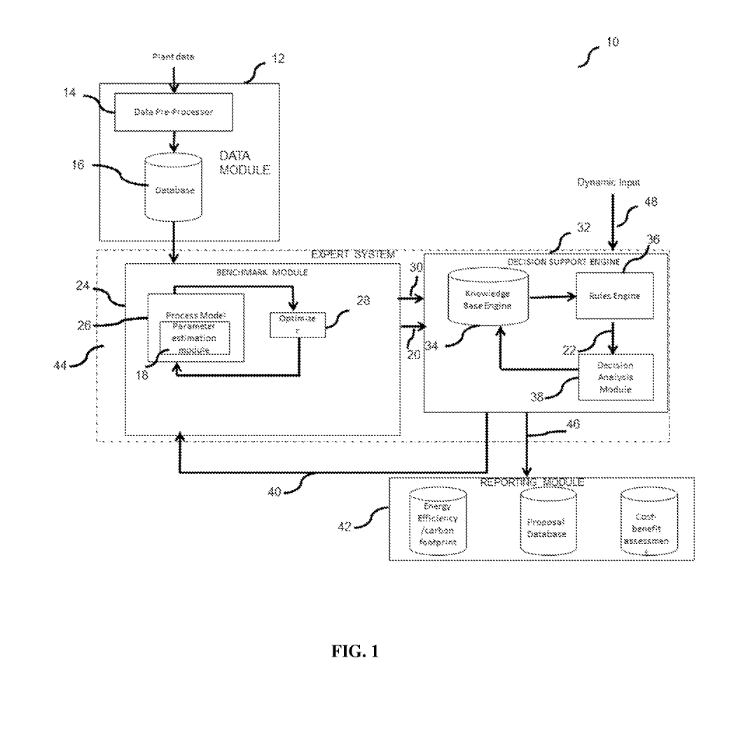

FIG. 1 is a diagrammatic view of an exemplary system 10 for obtaining a validated performance solution 46 for a plant. The system 10 includes one or more processors (not shown in figures). The system 10 including one or more processors has a data module 12 for obtaining plant data for calculating one or more performance metrics. The plant data may be obtained in real-time through sensors or may be obtained from a server that stores the plant data. The data module also includes in an exemplary embodiment a data pre-processor 14 for detecting and removing unsteady state data, gross errors and reconciling data to obtain noise free pre-processed data which is stored in a database 16 in the data module. The database 16 is located on a memory module operatively coupled to the one or more processors.

The pre-processed data from the database is sent to a benchmark module 24 present in the one or more processors. The benchmark module 24 includes a tunable process model 26 and an optimizer 28. In an exemplary embodiment the tunable process model 26 uses a parameter estimation module 18 for estimating the process model parameters for initial tuning of the process model. Then the process model is used to calculate one or more performance metrics, using plant process data from the data module. For example, the process model may include an energy/exergy calculator and carbon footprint calculator to calculate current performance metrics of the plant/process/equipments in terms of their energy efficiency and carbon footprint, as exemplary performance metrics, respectively.

The benchmark module uses the tunable process model to generate current performance metrics 20, and an optimizer 28 in combination with the tunable model and applied constraints to generate an initial benchmark 30.

The one or more processors can further include a decision support engine 32 having a knowledge base engine 34, a rules engine 36 and a decision analysis module 38. The decision support engine 32 can, for example, use a dynamic input 48 to generate a validated performance solution 46 for the plant, as explained herein below in more detail. The dynamic input includes but is not limited to a user preference, a plant and equipment condition that may change in space and/or time.

The initial benchmark 30 and the current performance metrics 20 obtained from the benchmark module 24 can be stored in a knowledge base engine 34. The current performance metrics 20 is compared with the initial benchmark 30 by a rules engine 36 on the basis of the dynamic input 48 and an output 22 is generated. The output 22 of the rules engine 36 is validated by a what-if analysis done by a decision analysis module 38 residing in the decision support engine 32. Decisions and validations referred herein relate to estimation of benefits from proposed validated performance solution. The decision analysis module 38 also gives flexibility to the user to evaluate any design modifications for energy efficiency improvements. If the output of the rules engine meets the dynamic input, then the output is provided as the validated performance solution. If the output does not meet the dynamic input, then the initial benchmark is evolved by relaxing some constraints either by the rules engine or by user action or by automated system action (for example, the system 10 can initiate an automated maintenance process for cleaning of the membrane in order to relax constraint on flow, pressure etc.). The relaxed constraints and the dynamic input are sent as feedback to the benchmark module, where the process model is retuned and the optimizer is used on the output of the process model to generate the evolved benchmark. The evolved benchmark and current performance metrics are now evaluated by the decision support engine 32 to determine if the evolved benchmark meets the dynamic input, by again using the rules engine and decision analysis modules as explained herein. This can be repeated until a validated performance solution meeting the dynamic input is obtained.

The one or more processors can further include a reporting module 42 that generates a performance report that includes information for the validated performance solution for operations and design improvements along with cost-benefit assessment. The performance reports can include an energy efficiency report and carbon footprint report, and other such reports as desired by the operators/managers of the plant. The performance report is useful for instant decision making by the users, operators, managers of the plant or any interested party.

It would be appreciated by those skilled in the art that the benchmark module, and the decision support engine may be integrated into an expert system 44 for energy management or monitoring for the plant. Further, the system may be provided as a web-based tool through appropriate user interfaces and may also be provided as a service for expert energy audits/assessment for the plants. In an exemplary embodiment, the expert system can receive simulated data for a plant. In an exemplary implementation, the customers may enter their own data and check the results on a web platform remotely to provide a simulated or dynamic environment to generate the validated performance solution. A dashboard may be additionally provided to view the results in addition to reports from the reporting module. The system may also incorporate as rules or as knowledge base additional features such as inclusion of local/governmental specifications during execution and reporting. The term rules herein refer to programmed logic implementable on a programmable electronic device such as a controller, field programmable gate array (FPGA), application specific integrated circuit (ASIC), etc.

It would be also appreciated that the performance evaluation system as described herein is applicable over a wide range of processing plants. As an example, the application to reverse osmosis (RO) Desalination Plant is described herein as a non-limiting example. The RO Desalination Plant includes (e.g., consists of) multiple RO trains, where an individual RO train performance/condition can be judged by multiple key performance indices (KPIs) such as its specific electricity consumption, membrane pressure drop, permeate recovery for a train, % load distribution etc. The performance of an overall “Plant” (which consisting of these trains) is directly influenced by the performance of these individual trains.

As an example, the multiple objectives that are of interest to a “User” are Product Recovery and Specific energy (electricity) consumption from the system. These objectives can be conflicting considering the variable space of interest.

Using the exemplary system 10 as disclosed herein, plant data for energy assessment of an RO section as described herein above is collected, pre-processed and reconciled in the data pre-processor 14 of the data module 12. The pre-processed data is stored in the database 16.

Next, the parameter estimation module 18 is used along with the pre-processed data from the database 16 for deriving the process model or tuning an existing process model, referred to herein as tunable process model 26 in the benchmark module 24. The process model is derived which takes variables like feed flow rate, pressure, feed temperature, feed quality to individual trains, electricity consumption in pumps etc as a process inputs from the process database and calculates KPIs and the objectives (as defined in next paragraph) as outputs.

This model is then used within a multi-objective optimization framework by the optimizer 28 to derive the relationship between various conflicting objectives in the optimal objective function space to generate an initial benchmark. Exemplary conflicting objectives involved are throughput maximization, total cost minimization, minimization of permeate concentration, etc. An example of constraints can be some upper and lower limit for % load distribution for each of the trains. The constraints on the input variables and the calculated objectives make an input to the optimizer 28. The optimizer obtains the optimal solution that is the initial benchmark, which refers to the best set points for input variables that meet the above exemplary objectives while satisfying the constraints.

The initial benchmark 30 is used as in input to the decision support engine 32, along with dynamic input 48, within a multi-criteria decision making framework, and is evaluated by the rules engine 36 of the expert system. The output of the rules engine is validated by a what-if analysis done by a decision analysis module 38 residing in the decision support engine 32. If the output of the rules engine meets the user preferences, i.e., the constraints on the plant, then the output is reported as the validated energy solution. If the output does not meet the user preference, i.e., the constraints on the plant, then the initial benchmark is evolved by relaxing some constraints either by the rules engine or by user action.

As an example, one of the following two cases could be an output from the “Rules Engine”
1. The “User” preferences are not met, and the following “actions” are evaluated by the “Rules Engine”
   a. Clean membrane “XY” or initiate maintenance process for cleaning membrane “XY”
   b. Replace High pressure pump drive to VFD

It may be noted that the above two cases act a trigger for evolution of the benchmark. As an example, the cleaning of membrane will update the membrane model parameters and also relax constraints on % load distribution for the given train with the “Clean” membrane dynamically. As a result a different optimal solution will be generated resulting in evolution of a new benchmark i.e a evolved benchmark. The above “actions” can be taken by “Rule Engine” in a prioritized manner to meet the “User” defined objectives.
2. The “User” preference are met, the following “actions” are recommended to the “User” or performed by the performance evaluation sytem
   a. Redistribute load to trains—“User” or the performance evaluation system shall increase load on train 1 by XX % and reduce load on train 2 by YY %.

It may be noted that this case uses the initial benchmark to suggest solutions to the “User” or to implement solutions automatically without user intervention.

It would be appreciated here that the evolved benchmark could evolve as both the plant conditions and user preference change. The change in plant conditions includes unavailability of certain units, fouling of membrane, wear and tear of the equipments, etc. Examples of user preference or constraints on the plant include preference for one or more objectives like production/energy, additional constraints such as local/governmental requirements; and so forth.

The decision analysis module 38 performs and tests the above “actions” to evaluate and quantify improvements and the impact of the validated performance solution, which is referred to in this case as a validated energy solution on the plant. The quantified improvements for example X % improvement in recovery and/or Y % reduction in specific energy consumption along with “actions” make the proposals database in the reporting module 42. The cost-benefit assessment works in parallel where any investments relating to cleaning or replacement bear a cost to the customer and the resulting improvements are translated into benefits.

The outputs from the reporting module 42 can also include recommendations or the validated energy solution for the RO section that may include actions for maintenance of one or more equipments such as pumps, change of a fixed drive of a pump with a variable frequency drive, cleaning of an RO membrane, redistribution of flow to RO trains etc. All these proposals can be listed along with a cost-benefit analysis in an energy assessment report from the reporting module 42. It would be appreciated by those skilled in the art that the reports can be made available through a user interface on a web tool, or through electronic mail or printed by an output device or through any other suitable interface. The reports may also be stored for future retrieval purpose.

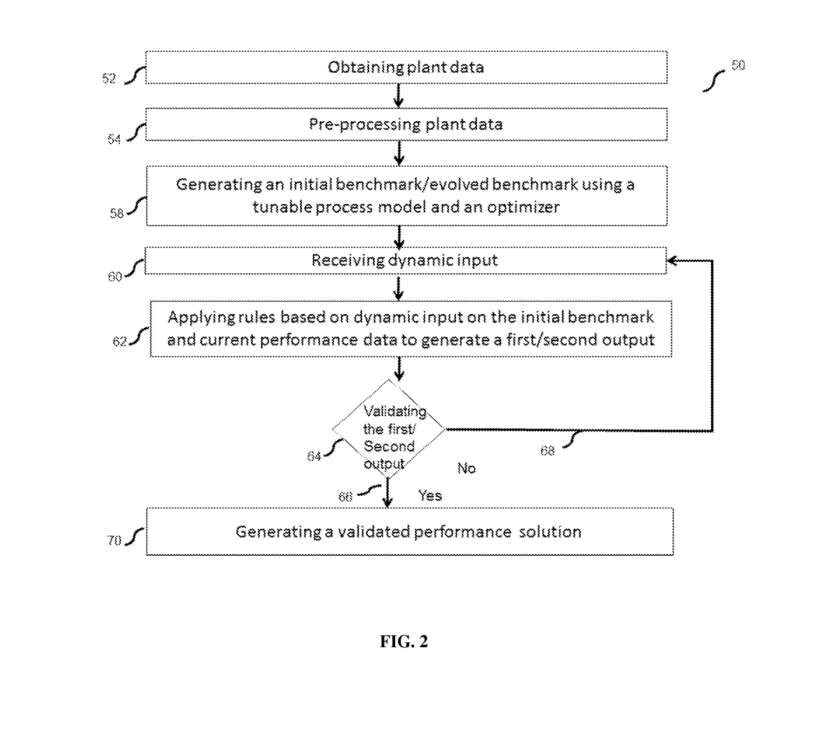

Now turning to FIG. 2, an exemplary method for obtaining a validated performance solution for a plant is illustrated in flowchart 50. As mentioned herein, the method can include a step 52 for obtaining plant data and a step 54 for pre-processing the plant data. At step 58, the pre-processed plant data and performance metrics are used by a process model and an optimizer along with some constraints to generate an initial benchmark. This initial benchmark and current performance metrics are matched with a dynamic input received at step 60 by using rules at step 62.

The output of step 62, which would be the first output when the method is implemented for the first time, is validated at step 64 by a what-if analysis. If the first output at step 62 meets the specifications of the dynamic input, then the first output is reported as the validated performance solution as indicated by reference numeral 66. If the first output does not meet the specifications of the dynamic input, then the initial benchmark is evolved or evolved by relaxing some constraints either by the rules engine or by user action (for example, cleaning of membrane would relax constraint on flow, pressure etc). The relaxed constraints and the dynamic input are sent as feedback to the benchmark module as shown by feedback loop 68, where the process model is retuned and the optimizer is used to generate the evolved benchmark and steps 62 and 64 are repeated with second, third outputs and so on, until a validated performance solution meeting the user preference is obtained.

Different types of audit and analysis reports can then generated based on the validated performance solution at step 70 to facilitate the decision making process for implementing the validated performance solution in the plant.

One skilled in the art will understand that the system and method described herein can be implemented as a mix of hardware and software program product in an exemplary embodiment. The hardware can include computation equipement, such as one or more processors, one or more computer storage mediums, network interfaces, etc., for implementation of the software program product. Some exemplary features that are used to describe the hardware or computer that are desirable for operation of an exemplary system as disclosed herein can include, but not limited to, processor speed, RAM, hard drive, hard drive speed, a monitor with suitable resolution, a pointing device such as a mouse, connectors such universal serial bus (USB), and the like, and combinations thereof. Other capabilities such as communication means may also be included, and this may be achieved through LAN, wireless LAN, phone line, Bluetooth, and the like, and combinations thereof. Other hardware and software capabilities to enable operation of an exemplary system as disclosed herein will be apparent to those skilled in the art, and is contemplated to be within the scope of the invention.

The method, system, and tool described herein can considerably enhance the quality of plant related efficiency services delivered to a customer. The method, system, and tool described herein can reduce the services cost and also lead to improved remote monitoring and related energy efficiency services. Further, the method, system, and tool described herein can be used for generation of intelligence of plant performances over time that is a useful indication to customers on benchmarking their plants compared to best in class.

While only certain features of the invention have been illustrated and described herein in detail, many modifications and changes will be apparent to those skilled in the art. It is, therefore, to be understood that the appended claims are intended to cover all such modifications and changes as fall within the true spirit of the invention.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

We claim:

1. A method for obtaining a validated performance solution for a plant, wherein the plant includes a performance evaulation system having at least one processor and at least one memory module, the method comprising:
obtaining, by the at least one processor, plant data for calculating one or more performance metrics;
generating, by the at least one processor, an initial benchmark and current performance metrics for the plant using a tunable process model and an optimizer;
applying, by the at least one processor, rules on the initial benchmark and the current performance metrics based on a dynamic input and generating a first output;
validating, by the at least one processor, if the first output meets the dynamic input using a what-if analysis;
generating, by the at least one processor, an evolved benchmark based on the dynamic input by re-tuning the tunable process model;
applying, by the at least one processor, rules on the evolved benchmark and the current performance metrics and generating a second output; and
providing, by the at least one processor, a validated performance solution, wherein the validated performance solution is based on at least one of the initial benchmark or the evolved benchmark and the dynamic input.

2. The method of claim 1, comprising:
pre-processing the plant data before calculating the current performance metrics.

3. The method of claim 3, comprising:
re-tuning the tunable process model based on inputs from a decision support engine and/or the dynamic input.

4. The method of claim 3, wherein the optimizer uses a tunable process model and one or more relaxed constraints to generate the evolved benchmark.

5. The method of claim 1, comprising:
generating one or more reports based on the validated performance solution.

6. The method of claim 1, wherein the dynamic input comprises:
at least one of a user preference, a plant condition, an equipment condition, or a combination thereof.

7. The method of claim 6, wherein the dynamic input changes in time and/or space.

8. The method of claim 1, wherein the plant data is at least one of a real-time data from one or more sensors or a stored data.

9. A software program product for non-transitory storage of a computer program which upon execution by a computer, will perform the method of claim 1.

10. The software program product of claim 9, wherein the software is web-enabled.

11. The software program product of claim 9, in combination with a computer and graphical user interface, wherein user preferences are received through the graphical user interface.

12. A performance evaluation system for obtaining a validated performance solution for a plant, the system comprising:
at least one processor, the at least one processor including:
a data module for obtaining, pre-processing and storing plant data;
a benchmark module having a tunable process model and an optimizer for providing at least one of an initial benchmark or a evolved benchmark; and
a decision support engine having a knowledge base engine, a rules engine and a decision analysis module to generate a validated performance solution for a plant based on a dynamic input.

13. The performance evaluation system of claim 12 comprising:
a reporting module for generating reports based on the validated performance solution.

14. The performance evaluation system of claim 12, wherein the benchmark module and the decision support module are integrated in an expert system.

15. The performance evaluation system of claim 12, wherein the rules engine contains one or more rules to address the dynamic input.

16. The performance evaluation system of claim 15, wherein the one or more rules and the dynamic input are used to generate the evolved benchmark.

17. The performance evaluation system of claim 12, wherein the decision analysis module is configured to evaluate an impact of the validated performance solution on a plant.

18. The performance evaluation system of claim 12, wherein the dynamic input comprises:
at least one of a user preference, a plant condition, an equipment condition, or a combination thereof.

19. The performance evaluation system of claim 18, wherein the dynamic input will change in time and/or space.

20. The performance evaluation system of claim 12, wherein the plant data is at least one of a real-time data or a stored data.
